(19) United States
(12) Patent Application Publication
(10) Pub. No.: US 2013/0185207 A1
(43) Pub. Date: Jul. 18, 2013

(54) METHOD AND SYSTEM FOR ONLINE AUTHENTICATION USING A CREDIT/DEBIT CARD PROCESSING SYSTEM

(71) Applicants: Garry LYONS, Dublin (IE); Oran CUMMINS, Dublin (IE); Theunis Johannes GERBER, Wildwood, MO (US); Anthony JM HAYES, Newtown, CT (US); Richard ROZBICKI, Danbury, CT (US)

(72) Inventors: Garry LYONS, Dublin (IE); Oran CUMMINS, Dublin (IE); Theunis Johannes GERBER, Wildwood, MO (US); Anthony JM HAYES, Newtown, CT (US); Richard ROZBICKI, Danbury, CT (US)

(73) Assignee: MASTERCARD INTERNATIONAL INCORPORATED, Purchase, NY (US)

(21) Appl. No.: 13/351,615

(22) Filed: Jan. 17, 2012

(51) Int. Cl. G06Q 20/40

(52) U.S. Cl. 705/44

(57) ABSTRACT

A system for online authentication using a payment card processing system, the system comprises: a managing computer system of a payment card service provider, the managing computer system having a memory device capable of storing data associating identifying information of individual customers with payment card accounts, and a computer processor configured to: receive a request for personal information of a customer on a relying party website, and wherein the relying party website is a member of the payment card processing system; request and receive identifying information of the customer for at least one payment card of the customer; present at least one authentication question to the customer to validate the customer; and validate the customer upon receipt of at least one correct answer to the at least one authentication question.

### FIELD

The present invention relates to a systems and method for online authentication using a credit/debit card or payment card processing system, and more particularly, a system and method of online authentication, which enables a customer to gain access to personal information on websites of participants in the payment card processing system and/or payments-specific infrastructures.

### BACKGROUND

Customers or card holders of payment cards often want to access their personal information, which is hosted by participants (i.e., relying party) in the payment card system. However, customers often do not have the necessary authorization to access the information and/or the relying party may not have enough information about the customer to use in an authorization process for a variety of reasons including not wanting to be responsible for securing such information or support establishing the protocols for receiving and updating the information. Customers also may not want to give information that can be used for authentication to a particular website provider. Accordingly, it would be desirable to provide customers with access to private or confidential information usable in an authorization process that can be used by a participating or relying party website to permit or deny access to information.

### SUMMARY

In accordance with an exemplary embodiment, a system for online authentication using a payment card processing system, the system comprises: a managing computer system of a payment card service provider, the managing computer system having a memory device capable of storing data associating identifying information of individual customers with payment card accounts, and a computer processor configured to: receive a request for personal information of a customer on a relying party website, and wherein the relying party website is a member of the payment card processing system; request and receive identifying information of the customer for at least one payment card of the customer; present at least one authentication question to the customer to validate the customer; and validate the customer upon receipt of at least one correct answer to the at least one authentication question.

In accordance with another exemplary embodiment, a method for online authentication using a payment card processing system, the method comprises: receiving, in a managing computer system hosted by a payment card service provider, the managing computer system comprising a memory device capable of storing data associating identifying information of individual customers with payment card accounts, and a computer processor, a request for personal information of a customer from a relying party website, and wherein the relying party website is a member of the payment card processing system; establishing a secure web-session between the managing computer system of the payment card service provider and the relying party website; requesting and receiving, in the managing computer system, identifying information of the customer for at least one payment card of the customer; forwarding, from the managing computer system, at least one authentication question to the customer; receiving, in the managing computer system, at least one response to the at least one authentication question from the customer; and validating, in the managing computer system, the authentication of the customer upon receipt of at least one correct answer to the at least one authentication question.

### BRIEF DESCRIPTION OF THE DRAWINGS

The exemplary embodiments of the disclosed systems and methods can be better understood with reference to the following drawings and description. The components in the figures are not necessarily to scale, emphasis instead being placed upon illustrating the principles of exemplary embodiments of the disclosed system. Moreover, in the figures, like reference numerals designate corresponding parts through the different views.

FIG. 1 illustrates a high level diagram of a system architecture that may be employed in accordance with an exemplary embodiment.

FIG. 2 illustrates a block diagram of a managing computer system for a payment card service provider in accordance with an exemplary embodiment.

FIG. 3 illustrates a flow chart illustrating the process in which the system of online authentication using a payment card processing system can be carried out.

FIG. 4 illustrates another flow chart illustrating the process in which the system of online authentication using a payment card processing system can be carried out.

FIG. 5 illustrates a flow chart illustrating the process in which the online authentication using a payment card processing system can be carried out.

Further areas of applicability of the present disclosure will become apparent from the detailed description provided hereinafter. It should be understood that the detailed description and exemplary embodiments are intended for purposes of illustration only. Thus, the detailed description and exemplary embodiments are not intended to necessarily limit the scope of the disclosure.

### DETAILED DESCRIPTION

The system and method for online authentication using a payment card processing system will now be described by reference to the accompanying drawings in which like elements are described with like figure numbers. It should be noted that the claimed invention is not limited to these particular embodiments but rather fully encompasses variations and modifications which may occur to those skilled in the art.

In accordance with an exemplary embodiment, the system and method described herein provide a framework to utilize customer information via an online authentication system and which utilizes a payment card processing system. In addition, the system and method provide online access to personal data having a level of security, which meets the needs and desires of the relying party and customer within the payment card processing system

A payment card is a card that can be presented by the cardholder (e.g., customer, an authorized user, etc.) to make a payment. By way of example, and without limiting the generality of the foregoing, a payment card can be a credit card, debit card, charge card, stored-value card, prepaid card, and/or other payment device, such as a phone or key fob, on a point-of-sale terminal reader. In addition, a payment card can include a virtual card, which does not have an actual card but is virtual in nature. It is noted that as used herein, the term “customer”, “cardholder,” “card user,” and/or “card recipient” can be used interchangeably and can include any user who holds a payment card for making purchases of goods and/or services. Further, as used herein in, the term “issuer” or “attribute provider” can include, for example, a financial institution (i.e., bank) issuing a card, a merchant issuing a merchant specific card, a stand-in processor configured to act on-behalf of the card-issuer, credit bureau that has card related and/or other consumer information that can be referenced in a verification process, or any other suitable institution authorized and/or configured to issue a financial card. Furthermore, in accordance with an exemplary embodiment, the attribute provider can be a payment card processing system.

As used herein, the term “transaction acquirer” or “relying party” can include, for example, a merchant, a merchant terminal, an automated teller machine (ATM), or any other suitable institution or device configured to initiate a financial transaction per the request of the customer or cardholder. Additionally, the relying party can be unrelated to a financial transaction or financial transaction system, but rather be any data access point that would like to authenticate a user before permitting access to data or for that matter a physical location. For instance, a customer wanting to access information or a physical location might be asked it input financial card information either then or previously, and that information be used in the present system to access through payment processing system information used in a challenge question/response mechanism as disclosed herein.

A “payment card processing system” or “credit card processing networks”, such as the MasterCard® network, now exist, allowing consumers to use one payment card to shop at a variety of merchants. With this type of payment card, a card issuer or attribute provider, such as a bank, extends credit to a customer to purchase products or services. When a customer makes a purchase from an approved merchant, the card number and amount of the purchase, along with other relevant information, are transmitted via the processing network to a processing center which verifies that the card has not been reported lost or stolen and that the card's credit limit has not been exceeded. In some cases, the customer's signature is also verified. The customer is required to repay the bank for the purchases, generally on a monthly basis. Typically, if the bank is not fully repaid by the due date, the customer incurs a finance charge. The card issuer or attribute provider may also charge an annual fee. In accordance with another exemplary embodiment, the payment card processing system can include payments-specific infrastructures, such as Electronic Funds Transfer (EFT), which includes any electronic exchange or transfer of money from one account to another, either within a single financial institution (issuer or attribute provider) or across multiple institutions, through computer-based systems.

Customers or card holders of payment cards often want to access personal information, which is hosted by the transaction acquirer or relying party. Transaction acquires or relying parties are participants in the payment card system and often have personal information of the customer that the customer may want to access. However, often customers do not have the necessary authorization to access the personal information, and/or the holder of the information generally needs to authenticate the person. Accordingly, it would be desirable to provide customers with access to personal or other potentially confidential or private information hosted on a relying party website.

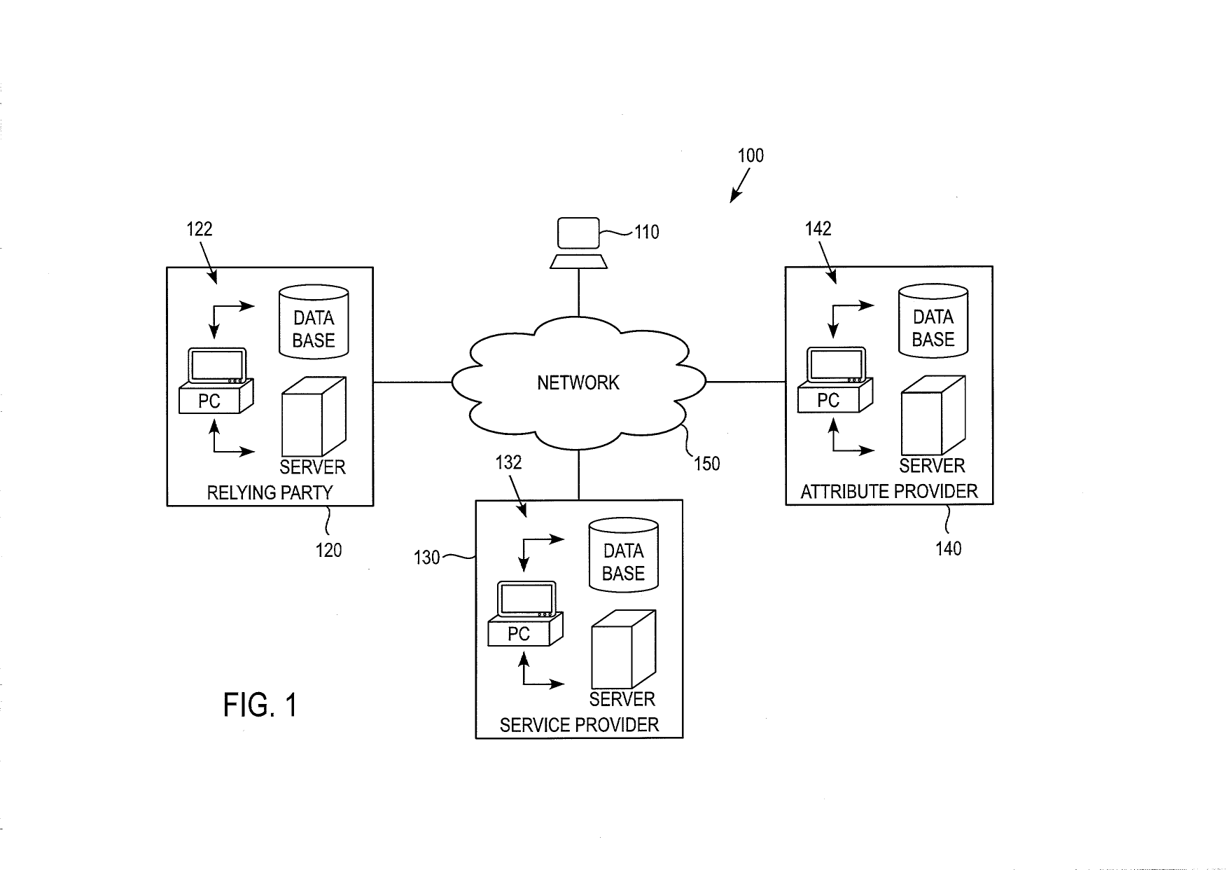

FIG. 1 illustrates a high level diagram of a system architecture that may be employed in accordance with an exemplary embodiment. As shown in FIG. 1, the system 100 includes a client or client device 110, a computer system 122 of a relying party website 120, a managing computer system 132 for a payment card service provider 130, a computer system 142 for an attribute provider 140, and a network 150, which connects the client or client device 110, the relying party website 120, service provider 130 and the attribute provider 142 to one another.

The client or client device 110 preferably includes a processor or central processing unit (CPU), one or more memories 210 for storing software programs and data. The client or client device 110 also preferably include an operating system (OS) 220, which manages the computer hardware and provides common services for efficient execution of various software programs. The processor or CPU 230 carries out the instructions of a computer program, which operates and/or controls at least a portion of the functionality of the client device 110. Examples of client device 110 include and are not limited to personal computers, tablet computers, smart phones, and/or personal digital assistants (PDAs), which include a web browser function for searching websites and the like.

The relying party website 120 for a party relying on the service is preferably a collection of related web pages containing personal information in the form of images, videos, data and/or other digital assets. The replying party website 120 is hosted on at least one web server, which is accessible via the network 150.

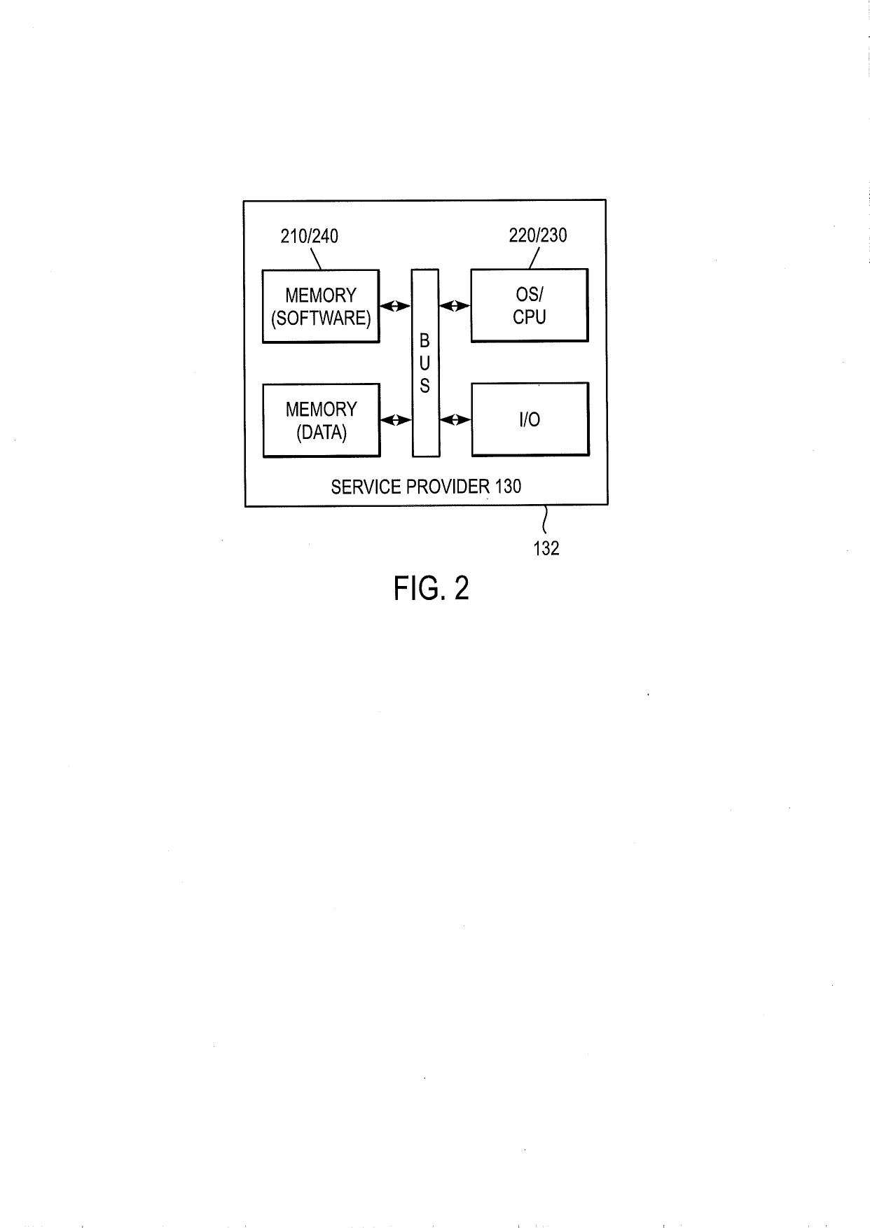

The managing computer system 132 for the payment card service provider 130 as shown in FIG. 2 includes at least one memory device 210 capable of storing data associating identifying information of individual customers with payment card accounts, a computer processor 220, and an operating system (OS) 230, which manages the computer hardware and provides common services for efficient execution of various software programs 240. The processor 220 (or CPU) carries out the instructions of a computer program, which operates and/or controls at least a portion of the functionality of the managing computer system 130.

The computer system 142 for the attribute provider 140 preferably includes a processor or central processing unit (CPU), one or more memories for storing software programs and data. An operating system (OS) manages the computer hardware and provides common services for efficient execution of various software programs. The processor or CPU carries out the instructions of a computer program, which operates and/or controls at least a portion of the functionality of the attribute provider computer system 142.

The network 150 may include a public telecommunication line and/or a network (e.g., LAN or WAN) 150, but any form of communications network or system, public or private would likely due. Examples of the telecommunication line and/or network 150 consistent with embodiments as described herein include, but are not limited to, telecommunication or telephone lines, the Internet, an intranet, a local area network (LAN), a wide area network (WAN) and/or a wireless connection using radio frequency (RF), optic and/or infrared (IR) transmission, and combinations thereof, to name a few of the more common communications systems.

As illustrated in FIG. 2, the managing computer system 132 of the service provider 130 includes at least one memory device 210, which may be any form of data storage device including but not limited to electronic, magnetic, optical recording mechanisms, combinations thereof or any other form of memory device capable of storing data which associates identification information of individual customers with payment card accounts issued by the attribute provider (or card issuer) to the customer. It is noted that as used herein, a customer may be the cardholder or an authorized user of the payment card who is not the cardholder. The managing computer system 132 also includes a computer processor 220, which may be in the form of a stand-alone computer, a distributed computing system, a centralized computing system, a network server with communication modules and other processors, or nearly any other automated information processing system configured to receive requests from relying parties 122 (or merchants).

Typically, the authorization request from the relying party (or merchant) includes various data regarding the identity of the payment card account, the type and amount of the transaction, merchant data information, and additionally the geographic origin of the request for authorization. The origin of the request for authorization may be generated by a merchant terminal (interface) at a fixed location for card-present transactions, or from information received during a transaction regarding the customer's IP (internet protocol) address, computer identification that indicates the location of the computer, such as the customer's home computer or business desk-top computer that the customer had previously identified as being associated or linked with the payment card account, or nearly any other form of information that would tend to identify the origin of the request for authorization.

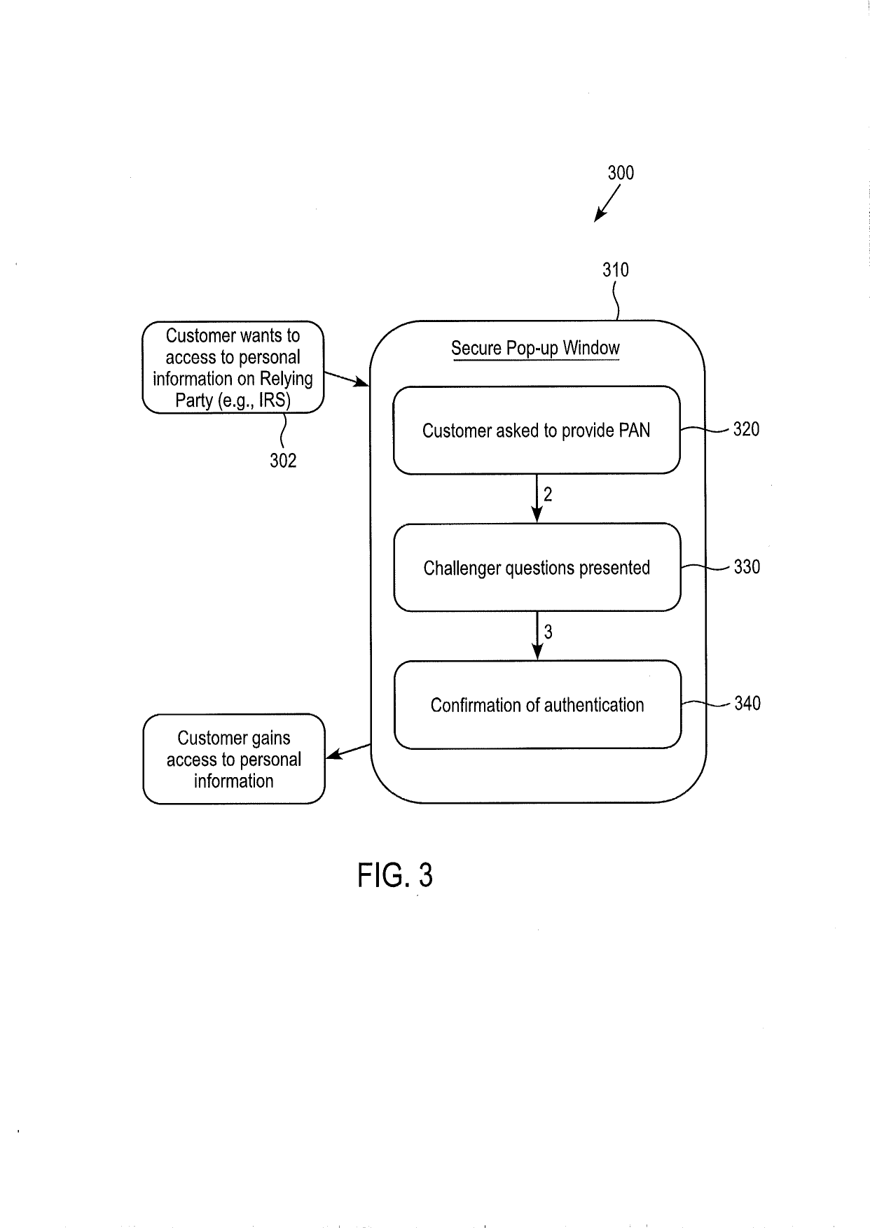

FIG. 3 illustrates a flow chart illustrating the process 300 in which the system of online authentication using a payment card processing system can be carried out. As shown in FIG. 3, in accordance with an exemplary embodiment, a customer 302 has a desire to access personal information for instance on a relying party website (e.g., Internal Revenue Server (IRS)). Although, the customer 302 wishes to access his personal information on the relying party website 120, the customer often will not have the necessary authorizations to access the information. In accordance with an exemplary embodiment, the relying party website 120 is preferably a participant in the payment card processing system. The website 120 of the relying party 122 includes at least one webpage having a visible “active” or “activation” icon for the online authentication system. The active icon and/or activation icon provides a link to the payment card processing computer system 120, which is configured to provide the customer with access and/or the ability to gain access to the personal information hosted by the relying party 122 and/or relying party website 120 upon authentication of the customer 302.

In accordance with an exemplary embodiment, the customer 302 preferably clicks on the active icon and/or activation icon, which triggers a pop-up window and/or interstitial webpage 310. Upon initiation of the pop-up window and/or interstitial webpage 310, the relying party website provides the payment card service provider 132 with information about the relying party 122 and the customer 302, including but not limited to: a unique network ID (i.e., network identifier) to identify the relying party 122 and confirm that the request for access to personal information is a legitimate request; case code to create an identifier/log for the particular customer/session; information pertaining to the customer 302 (e.g., name, date of birth (DOB), Social Security number (SSN), etc.), which is needed to access the personal information the customer 302; and a level of authentication (i.e., an authentication score) required to allow the customer to gain access to their personal information on the relying party website 120.

Within the pop-up window, in step 320, the customer is preferably asked to enter the primary account number (or “PAN”) for at least one of the customer's payment cards. Note, this information may have been previously gathered and stored. The managing computer system 130 for the payment card service provider 132 checks the first four digits (e.g., MasterCard®, Visa® or Discover®) or any number of digits or numbers of the primary account number (or PAN) to confirm that the issuing bank or attribute provider 142 is a participant in payment card processing system. If the customer is a member of the payment card processing system, the remaining digits of the primary account number (PAN) are requested. If the payment card of the customer is not issued by an attribute provider, which is a member of the payment card processing service, the customer is prompted for a different payment card and the attribute provider details. For example, for an American Express® card and/or other payment cards having a 15-digit primary account number (or PAN), the system can be configured such that the system logic identifies the first four digits as American Express® (e.g., 37XX) and adjusts accordingly. Alternatively, the system can be configured to accept more or less than 4 numbers and/or digits typically associated with the 4 digit identifier for payments cards issued by MasterCard®, Visa®, Discover®, American Express®, and the like. For example, in accordance with an exemplary embodiment, the system can be configured to accept numbers and/or digits associated with phone numbers, insurance number, etc., which identify the customer and attribute provider. If the customer is eligible, the customer enters the complete primary account number (PAN) and submits the information to the managing computer system 130 of the payment card service provider 132 (i.e., by clicking OK, Send and/or Enter on a keyboard or graphical user interface and/or screen of the client device 110). The Customers' PAN information is passed onto the managing computer system 130 for the payment card service provider 132, which determines the identity of the attribute provider. Once the attribute provider 142 is identified, the managing computer system 130 send the computer system 140 of the attribute provider the PAN of the payment card of the customer, and a request for authentication and/or challenger questions based on the provided authentication needs of the relying party and/or relying party website. The attribute provider (or issuer) returns one or more (as required) authentication and/or challenger questions that need to be answered by the customer to obtain authentication. In accordance with an exemplary embodiment, one or more attribute providers may be requested to provide authentication and/or challenger questions for the consumer to respond to in order to achieve the authentication needs of the relying party. The one or more attribute providers can be one or more of the following: the issuer of the payment card, the payment card service provider (e.g., MasterCard), third party (e.g., credit bureau or other entity with consumer information), telephone and/or telecommunication companies, health maintenance organizations (HMO), managed care organizations (MCO), etc. In step 330, the managing computer system forwards the authentication and/or challenger questions to the relying party website, which presents the authentication and/or challenger questions to the customer within the existing pop-up window. In accordance with an exemplary embodiment, the payment card service provider can be one of a plurality of attribute providers providing questions for consumer response via the pop-up window for authentication.

The customer 302 answers the authentication and/or challenger questions and sends the answers to the managing computer system 130 for validation. If correct, in step 340, the managing computer system 130 derives and transmits the authentication score to the relying party website. The relying party website determines based on the returned score whether to allow customer access to information or not. In accordance with an exemplary embodiment, the pop-up window closes and the customer information is made available, if the authentication score meets the desired score of the relying party 122.

If any and/or all of the answers to the authentication and/or challenger questions are incorrect, the authentication and/or challenger questions are refreshed and re-presented to the customer at least one more time. The number of times that each customer is re-presented with the authentication and/or challenger questions is preferably set by the relying party and/or payment card service provider. In addition, the re-presented authentication and/or challenger question can be a new question and/or alternatively, a different question. If the customer is unable to correctly answer the one or more authentication and/or challenger questions, the customer is preferably locked-out of the relying party website 120. If the customer is locked-out of the relying party website, in accordance with an exemplary embodiment, the customer can obtain access to the private or confidential information hosted by the relying party or relying party website via a manual authentication process.

Once the customer gains access to private or confidential data on the relying party website via the authentication and/or challenger questions, in accordance with an alternative embodiment, the customer can to sign-up for an ongoing or frequent visitation program (Le., a “virtual vault”) with the payment card service provider. The “virtual vault” provides the customer with the ability to be pre-approved (e.g., pre-authentication) by providing information for pre-approval. The information can include a portion and/or all of their payment cards, utility company information, insurance policy information, etc., which can go through a series of pre-authorization checks and/or pre-approval with one or more of the various attribute providers. In accordance with an exemplary embodiment, the relying party website can also allow customer to see the level of authorization score that is required to obtain access to their personal information, and can provide the customer with the opportunity to increase the level of authentication (or assurance score) by submission of additional information in the form of security questions, etc. A pre-authorized customer would obviate the need to access the attribute provider each time and for example, only a personal identification number (or PIN) created during “virtual vault” set-up would be required to validate the customer. In addition, customers could be required to re-authenticate their “virtual vault” at a set and/or a predetermined time frame, i.e., every 3-months to maintain a proper level of ongoing security and protection. In accordance with an alternative embodiment, the re-authentication can depend on a certificate provided by the IDP and/or attribute provider, which can have varying expiration dates.

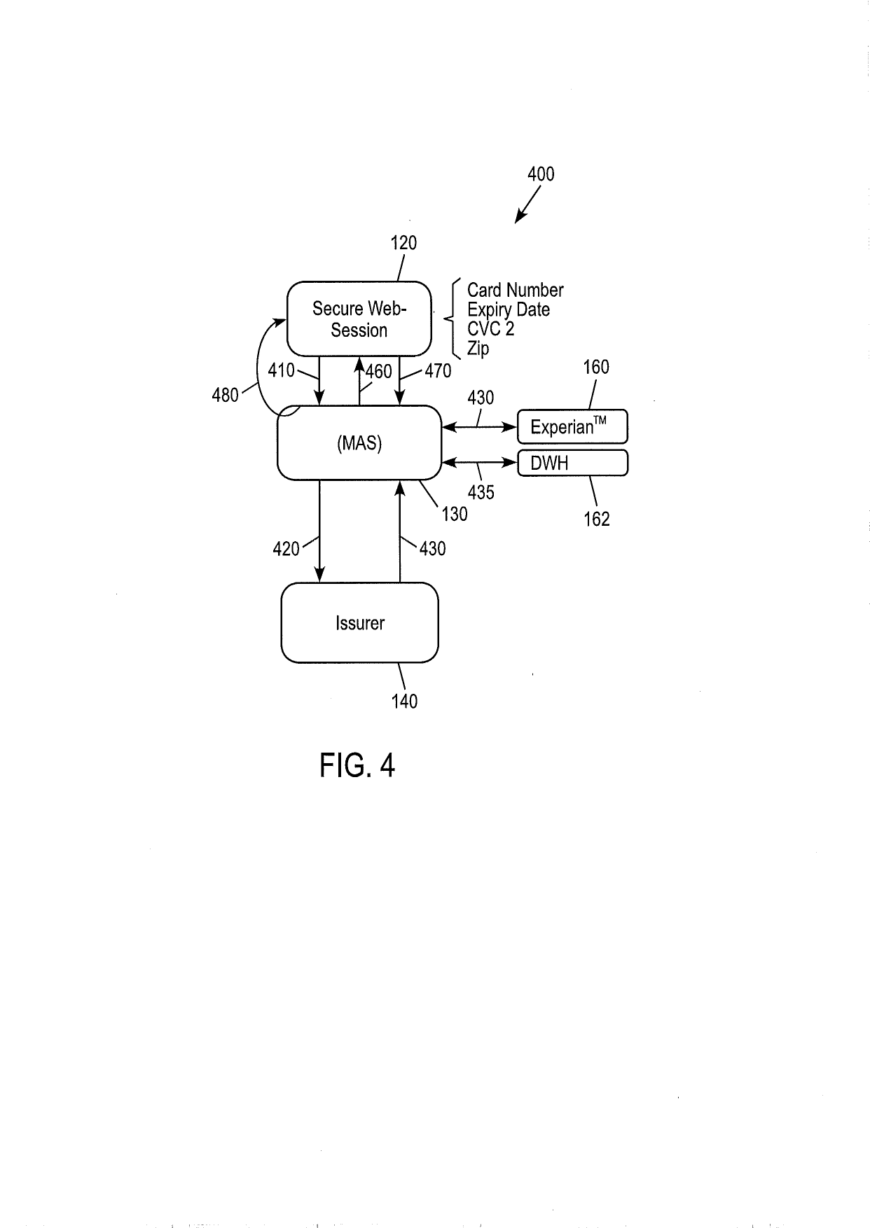

FIG. 4 illustrates another flow chart illustrating the process 400 in which the system of online authentication using a payment card processing system can be carried out. As shown in FIG. 4, in step 410, upon selection of the active icon, a secure web-session is established or generated between the customer and/or relying party website 120 and the managing computer system 132 of the payment service card provider 130. The customer 302 is requested to provide the primary account number (PAN), expiration date, CVC or CVC 2 (Card Verification Code), and/or zip code of the primary payment card holder, which is submitted to the managing computer system 132. In step 420, the managing computer system 132 sends to the attribute provider (or issuer), a request to validate the expiration date, CVC or CVC 2, and/or zip code provided by the customer. In accordance with an exemplary embodiment, for each of the online authentication request, the payment card service provider preferably receives a fee and/or transactional fee for the online authentication.

In step 430, the attribute provider 140 (or issuer) provides an authentication decision, if the payment card of the customer is authorized to proceed further with the request for personal information. If the customer is not authorized to proceed, the process stops and session ends. In step 440, in accordance with another exemplary embodiment, the managing computer system 132 sends a request (or call-out) to a first identifying party 160 (e.g., credit bureau or other third party attribute provider) using the primary account number (PAN) to request one or more authentication and/or challenger questions. The first identifying party 160 receives the request and sends one or more authentication and/or challenger questions to the managing computer system 132. In step 445, the managing computer system 132 sends another request (or call-out) to a second identifying party 162 to request one or more additional authentication and/or challenger questions. The second identifying party 162 receives the request and sends one or more authentication and/or challenger questions to the managing computer system 132. In accordance with an exemplary embodiment, the first and second identifying parties 160, 162 can be any company, database and/or other service, which collects and/or hosts personal information on customers through credit reports, lifestyle data and the like.

In step 450, a smart module within the managing computer system 132 selects one or more authentication and/or challenger questions to be posted to the customer 302. In step 460, the one or more authentication and/or challenger questions are posted to a pop-up window generated through the relying party website 120. In step 470, the customer responds to the one or more authentication and/or challenger questions, which are captured and validated by the managing computer system 132. In step 480, the authentication score is passed to the relying party website 120, and the decision to allow access to information is performed by the relying party based on the returned score. In accordance with an exemplary embodiment, where the relying party website 120 has communicated the acceptable minimum score, it may not be necessary for the relying party website 120 to transmit the acceptable minimum score to the managing computer system 132.

In accordance with an exemplary embodiment, each of the relying party websites can set a level of authentication for each customer and/or plurality of customers using an assurance score. The assurance score may be based on known attributes about a customer (or consumer) at the attribute provider (i.e., identifying party) and augmented with additional sources of information, along with other factors such as the uniqueness and lack of public awareness of what the answer might be, as well as other factors. In accordance with an exemplary embodiment, the relying party can set a minimum assurance score, which must be obtained in order to accept and assure that the proper identification of the customer has been received in order to access the personal information hosted by the relying party. For example, attributes can include customer information and experience, such as proper information established at time of account opening, number of times in which the customer has accessed the online authentication system, number of years with the attribute provider and/or identifying party, and/or information likely known only to the relying party. Each customer or consumer receives a score for each of the attributes, which generates an overall score (e.g., level of authentication and/or assurance score), which upon achieving a minimum assurance score provides the customer or consumer with access to the personal information hosted by the relying party. If a minimum assurance score is not obtained, the customer will be denied access to the personal information hosted by the relying party.

In addition, the method and systems as described herein preferably provide additional levels of security, which include and is not limited to the relying party does not receive any of the customer data, the relying party is required to provide proper authentication and/or validation (i.e., a “match key”) to establish a connection to the customer, and only the customer validates data with the relying party. In accordance with an exemplary embodiment, the online authentication system validates the attributer provider, which in turn validates the customer to the relying party and/or relying party website. The online authentication system also provides authentication and/or validation data (e.g., a “match key”) from the attribute provider to the relying party and/or relying party website.

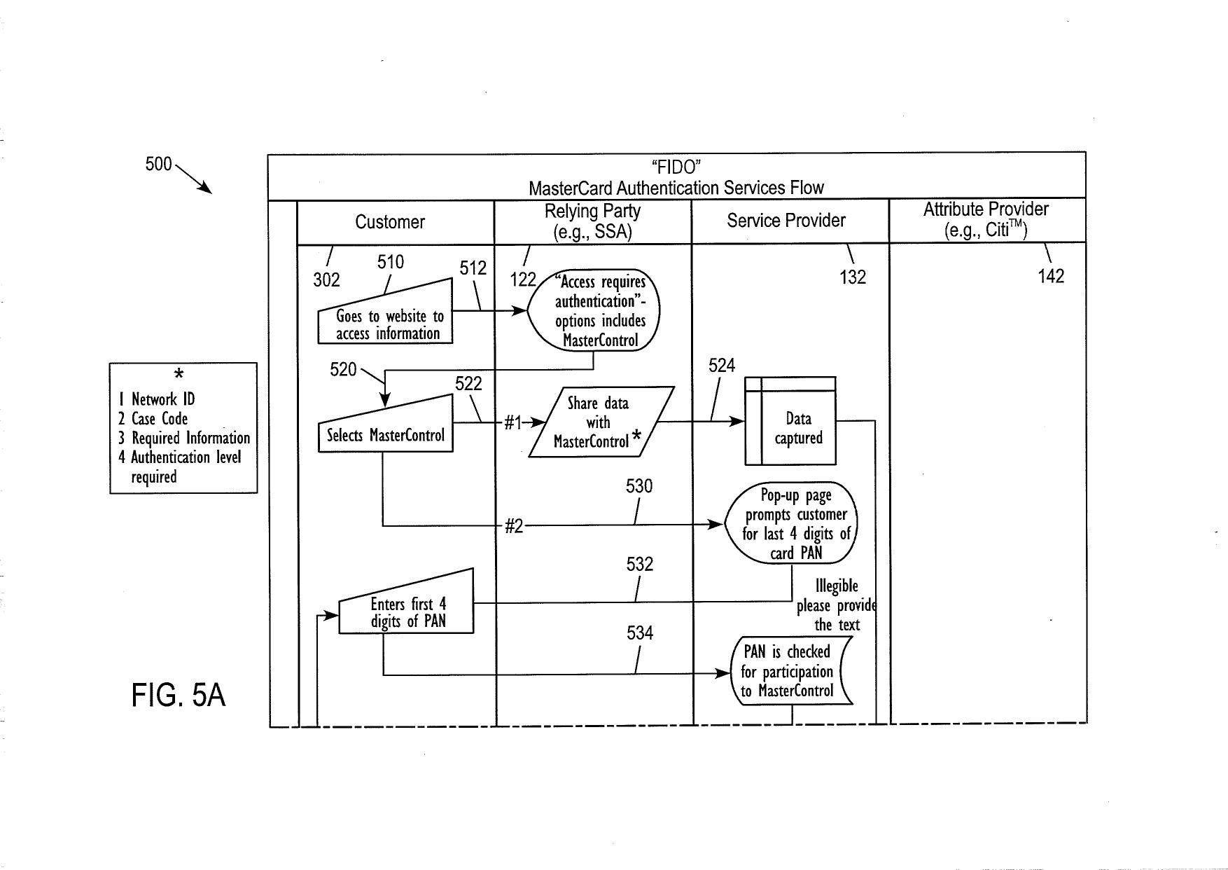

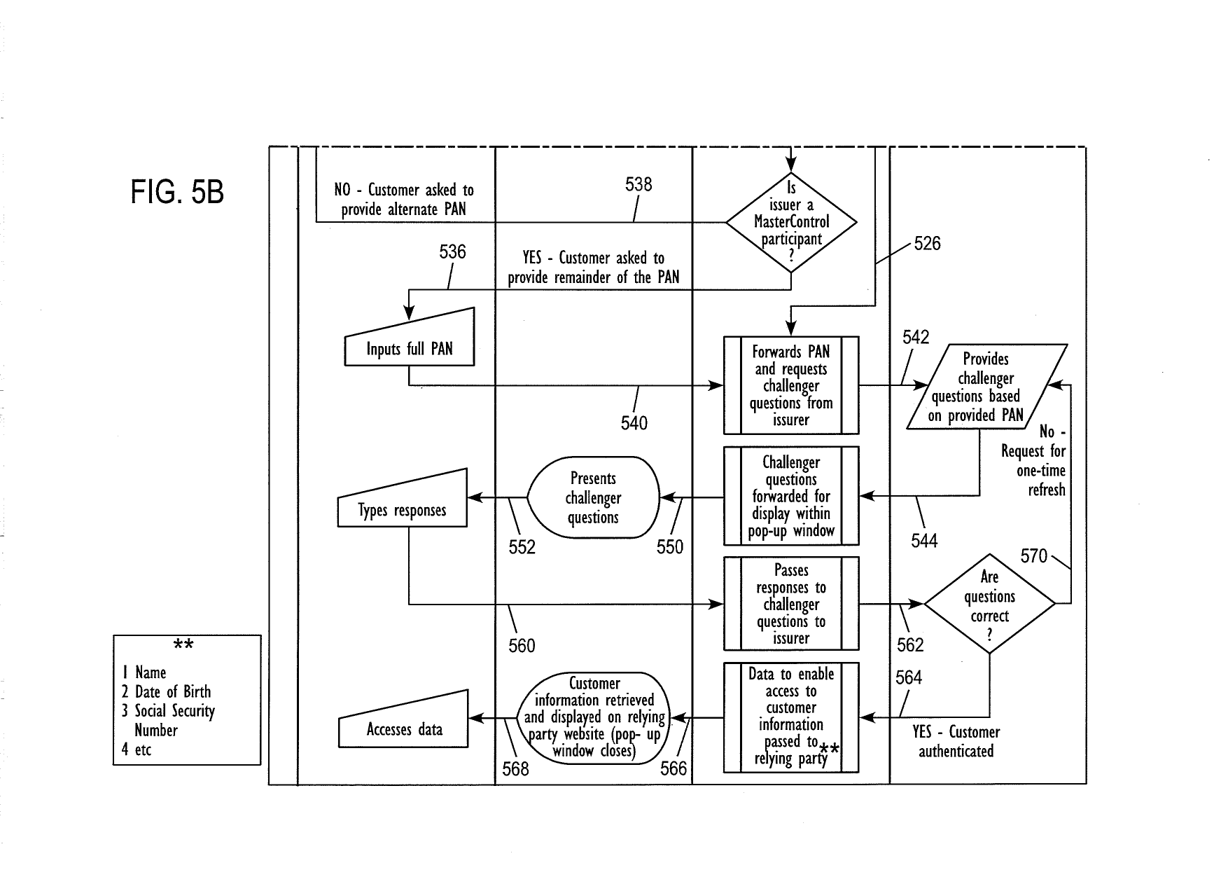

FIG. 5 (FIGS. 5A and 5B) illustrates a flow chart illustrating a process 500 in which the online authentication using a payment card processing system can be carried out. As shown in FIG. 5, the parties to the transaction include a customer 302 through a client 110 having a payment card having a primary account number (PAN), a relying party 122 having a website 120, a payment card service provider 130 having a managing computer system 132, and an attribute provider 140 (or issuer of the payment card) having a computer system 142. In step 510, the customer accesses a relying party website to request personal information of the customer, which is hosted by the relying party and/or relying party website. In step 512, the customer wishing to access the personal information hosted by the relying party and/or relying party website is advised that access to the personal information requires authorization through an active or activation icon, which connects the customer with a managing computer system of the payment card service provider.

In step 520, the customer selects the active or activation icon on the relying party website for example, which in step 530 generates a pop-up window on the client device of the customer. The customer 532 is prompted to provide a select number (i.e., the first 4 digits or numbers) of digits or numbers of the primary account number (PAN) of at least one payment card of the customer. In step 534, the customer enters the select number of digits and the payment card service provider checks the select number of digits (i.e., first four digits) of the primary account number (or PAN) to confirm that the attribute provider (or issuing bank) is a participant in payment card processing system. Of course, this step is not necessary, particularly if the system is widely adopted or otherwise the inconvenience of pushing to the next step and alerting the customer 532 at a different time is perceived to be better. If, the attribute provider is a member of the payment card processing system, in step 536, the managing computer system requests the customer enter the remaining digits of the primary account number. If the payment card of the customer is not issued by an attribute provider, which is a member of the payment card processing service, in step 538, the customer is prompted for a primary account number (PAN) for a different issuers' card (i.e., payment card issued by another attribute provider) in this exemplary embodiment.

In step 522, the relying party shares data received from the customer, which can include a network ID (identification), case code, required information, and authentication level (or assurance score) required to access the personal information hosted by the relying party's website. In step 524, the data received from the customer and relying party is sent to the payment card service provider, which is captured by the managing computer system of the payment card service provider.

If the customer is eligible to access personal information on the relying party website or as an initial step, in step 540, the customer enters the complete primary account number (i.e., eligible PAN) and sends the information to the managing computer system (i.e., by clicking OK, Send and/or Enter on the keyboard or graphical user interface of the client device for example). In step 542, the customers' PAN information is passed onto the managing computer system for the payment card service provider, which determines the attribute provider and sends the attribute provider the PAN and a request for authentication and/or challenger questions based on the authentication needs of the relying party site. In step 544, the attribute provider (or issuer) returns one or more (as required) authentication and/or challenger questions that need to be answered by the customer. In step 550, the managing computer system presents the authentication and/or challenger questions to the relying party website, which presents the authentication and/or challenger questions in step 552 to the customer within the existing pop-up window.

In step 560, the customer answers the authentication and/or challenger questions and sends the information to the managing computer system. In step 562, the managing computer system, which will validate the answers based on the answers provided by the attribute provider (or issuer). If correct, in step 564, the attribute provider sends a communication to the managing computer system that the customer is authorized to access the information requested. In step 566, the managing computer system passes an authentication score to the relying party website to enable access to the customer information. In step 568, the pop-up window closes and the customer information is made available through the relying party website.

If one or more of the answers to the authentication and/or challenger questions are incorrect, in step 570, the authentication and/or challenger questions are refreshed and re-presented to the customer at least one more time. The number of times that each customer is re-presented with the authentication and/or challenger can be set by the relying party and/or payment card service provider. The re-presented authentication and/or challenger question can be a new question and/or alternatively, a different question. If the customer is unable to correctly answer the one or more authentication and/or challenger questions, the customer as an option might be locked-out of the relying party website and will need to obtain access the personal information on the relying party website via a manual authentication process, or other action taken such as setting up a watch on the account, alerting the customer via a communication, or other action as appropriate.

The previous description of the various embodiments is provided to enable any person skilled in the art to make or use the invention recited in the accompanying claims of the disclosed system. While various exemplary embodiments of the disclosed system have been described above, it should be understood that they have been presented by way of example only, and not limitation. While exemplary embodiments of the disclosed system have been particularly shown and described with reference to embodiments thereof, it will be understood by those skilled in the art that many variations, modifications and alternative configurations may be made to the invention without departing from the spirit and scope of exemplary embodiments of the disclosed system.

Where methods described above indicate certain events occurring in certain order, the ordering of certain events may be modified. Moreover, while a process depicted as a flowchart, block diagram, etc., may describe the operations of the system in a sequential manner, it should be understood that many of the system's operations can occur concurrently.

Thus, the breadth and scope of exemplary embodiments of the disclosed system should not be limited by any of the above-described embodiments but should be defined only in accordance with the following claims and their equivalents.

What is claimed is:

1. A system for online authentication using a payment card processing system, the system comprising:
a managing computer system of a payment card service provider, the managing computer system having a memory device capable of storing data associating identifying information of individual customers with payment card accounts, and a computer processor configured to:
receive a request for personal information of a customer on a relying party website, and wherein the relying party website is a member of the payment card processing system;
request and receive identifying information of the customer for at least one payment card of the customer;
present at least one authentication question to the customer to validate the customer; and
validate the customer upon receipt of at least one correct answer to the at least one authentication question.

2. The system of claim 1, wherein the relying party website has a payment card service provider icon, which upon activation by the customer establishes a secure web-session between the managing computer system of the payment card service provider and a computer device of the customer.

3. The system of claim 1, wherein the identifying information of the customer for at least one of the payment cards of the customer is a primary account number (PAN) of the at least one payment card of the customer.

4. The system of claim 3, wherein the managing computer system further confirms that the primary account number (PAN) is a member of an attribute provider, and wherein the attribute provider is a participant of the payment card processing system of the payment card service provider.

5. The system of claim 1, wherein the relying party website provides the managing computer system with an unique Identifier (ID) to identify a replying party associated with the relying party website, creating an identifier for a customer associated with the request for personal information, providing information to the service card provider for the customer to access personal information, and providing the payment card service provider with a level of authentication required to allow the customer to gain access the personal information of the customer.

6. The system of claim 5, wherein the managing computer system of the payment card service provider identifies one or more attribute providers, and sends the one or more attribute providers a request for authentication questions based on the level of authentication required by the relying party website to access the personal information of the customer.

7. The system of claim 6, wherein the authentication questions are generated by the one or more attribute providers.

8. The system of claim 1, wherein the relying party requires the customer to obtain a required authentication score before providing the customer with access to the personal information hosted by the relying party website.

9. The system of claim 1, wherein if the customer is unable to correctly answer one or more of the one or more authentication questions, the authentication are represented.

10. The system of claim 1, further comprising generating an assurance score based on known attributes about the consumer and augmenting the assurance score with additional know information to generate a minimum score needed to provide the customer with access to personal information on the relying party website.

11. A method for online authentication using a payment card processing system, the method comprising:
receiving, in a managing computer system hosted by a payment card service provider, the managing computer system comprising a memory device capable of storing data associating identifying information of individual customers with payment card accounts, and a computer processor, a request for personal information of a customer from a relying party website, and wherein the relying party website is a member of the payment card processing system;
establishing a secure web-session between the managing computer system of the payment card service provider and the relying party website;
requesting and receiving, in the managing computer system, identifying information of the customer for at least one payment card of the customer;
forwarding, from the managing computer system, at least one authentication question to the customer;
receiving, in the managing computer system, at least one response to the at least one authentication question from the customer; and
validating, in the managing computer system, the authentication of the customer upon receipt of at least one correct answer to the at least one authentication question.

12. The method of claim 11, wherein the identifying information of the customer for at least one payment card of the customer comprises receiving, in the managing computer system, a primary account number (PAN) of the at least one payment card of the customer.

13. The method of claim 11, wherein the relying party website has payment card service provider icon, which upon activation by the customer establishes the secure web-session between the managing computer system of the payment card service provider and a computer device of the customer.

14. The method of claim 13, wherein in the managing computer system, confirming that the primary account number (PAN) is a member of an attribute provider, which is a participant of the payment card processing system of the payment card service provider.

15. The method of claim 11, wherein the relying party website provides the managing computer system with an unique Identifier (ID) to identify a replying party associated with the relying party website, creating an identifier for a customer associated with the request for personal information, providing information to the service card provider for the customer to access personal information, and providing the payment card service provider with a level of authentication required to allow the customer to gain access the personal information of the customer.

16. The method of claim 15, wherein the managing computer system of the payment card service provider identifies one or more attribute providers, and sends the one or more attribute providers a request for authentication questions based on the level of authentication required by the relying party website to access the personal information of the customer.

17. The method of claim 16, wherein the authentication questions are generated by the one or more attribute providers.

18. The method of claim 11, wherein the relying party website requires the customer to obtain a minimum required authentication score before providing the customer with access to the personal information hosted by the relying party website.

19. The method of claim 11, wherein if the customer is unable to correctly answer one or more of the one or more authentication questions, the authentication are represented.

20. The method of claim 11, further comprising generating an assurance score based on known attributes about the consumer and augmenting the assurance score with additional know information to generate a minimum score needed to provide the customer with access to personal information on the relying party website.
